(19) United States
(12) Patent Application Publication
(10) Pub. No.: US 2015/0077392 A1
(43) Pub. Date: Mar. 19, 2015

(54) TERMINAL, AND TERMINAL CONTROL METHOD AND APPARATUS

(71) Applicant: HUAWEI TECHNOLOGIES CO., LTD., Shenzhen (CN)

(72) Inventors: Yuanwang LIU, Shenzhen (CN); Min YE, Hangzhou (CN); Zhen HE, Shenzhen (CN)

(73) Assignee: HUAWEI TECHNOLOGIES CO., LTD., Shenzhen (CN)

(21) Appl. No.: 14/534,522

(22) Filed: Nov. 6, 2014

Related U.S. Application Data
(63) Continuation of application No. PCT/CN2014/075645, filed on Apr. 17, 2014.

(30) Foreign Application Priority Data
Sep. 17, 2013 (CN) 201310425980.5

(51) Int. Cl. G06F 3/041; G06F 3/044

(52) U.S. Cl. CPC G06F 3/0416; G06F 3/044; G06F 3/0414
USPC 345/174; 345/173

(57) ABSTRACT

Embodiments of the present invention relate to a terminal and a terminal control method and apparatus to solve a problem that a shortcut operation cannot be implemented on a terminal. The terminal includes: a pressure detecting apparatus configured to detect pressure on various positions in a first specified area on a surface of the terminal; an action detecting apparatus configured to detect a user action on a second specified area on the surface of the terminal; and a processor configured to execute, when it is determined that the first specified area on the surface of the terminal has more than a specified number of positions on which the pressure exceeds preset pressure, an operation corresponding to a user action on the second specified area on the surface of the terminal.

### CROSS-REFERENCE TO RELATED APPLICATIONS

This application is a continuation of International Application No. PCT/CN2014/075645, filed on Apr. 17, 2014, which claims priority to Chinese Patent Application No. 201310425980.5, filed on Sep. 17, 2013, both of which are hereby incorporated by reference in their entireties.

### TECHNICAL FIELD

Embodiments of the present invention relate to the field of terminal technologies, and in particular, to a terminal and a terminal control method and apparatus.

### BACKGROUND

As science and technology develop, an increasing number of touch screen terminals emerge in people's lives. Use of many mainstream touch screen terminals relies to a great extent on screen operations and, to complete one operation, a user needs to perform multiple actions in most cases.

For example, when a user is watching a video in full screen mode on a touch screen terminal, if the user wants to pause the video that is being playing, the user needs to tap the screen, so that the screen displays a virtual button, and then tap a pause button among the displayed virtual buttons to implement a pause operation. That is, a current touch screen terminal cannot implement a shortcut operation, thereby decreasing operation efficiency of a user and affecting use experience of the user.

### SUMMARY

Embodiments of the present invention provide a terminal, and a terminal control method and apparatus to solve a problem that a terminal cannot implement a shortcut operation.

According to a first aspect, a type of terminal is provided and includes:

a pressure detecting apparatus, configured to detect pressure on various positions in a first specified area on a surface of the terminal;

an action detecting apparatus, configured to detect a user action in a second specified area on the surface of the terminal; and

a processor, configured to execute, when it is determined that the first specified area on the surface of the terminal has more than a specified number of positions on which the pressure exceeds preset pressure, an operation corresponding to a user action in the second specified area on the surface of the terminal.

With reference to the first aspect, in a first possible implementation manner, the pressure detecting apparatus is specifically a pressure sensor bar or a capacitive touchscreen located on an inner side of the first specified area on the surface of the terminal, and the action detecting apparatus is specifically a capacitive touchscreen located on an inner side of the second specified area on the surface of the terminal.

With reference to the first aspect, in a second possible implementation manner, the first specified area is located in a lower part of a side of the terminal and the second specified area is located in an upper part of a side of the terminal.

With reference to the first aspect, in a third possible implementation manner, the specified number is any integer value within a range that is equal to or greater than 1.

With reference to the first aspect, the first possible implementation manner of the first aspect, the second possible implementation manner of the first aspect, or the third possible implementation manner of the first aspect, in a fourth possible implementation manner, the preset pressure is any value within a range that is from equal to or greater than 0.5 N to equal to or less than 2.5 N.

According to a second aspect, a terminal control method is provided and includes:

determining whether a first specified area on a surface of a terminal has more than a specified number of positions on which pressure exceeds preset pressure; and

executing, when it is determined that the first specified area on the surface of the terminal has more than the specified number of positions on which the pressure exceeds the preset pressure, an operation corresponding to a user action in a second specified area on the surface of the terminal.

With reference to the second aspect, in a first possible implementation manner, the specified number is any integer value within a range that is equal to or greater than 1.

With reference to the second aspect or the first possible implementation manner of the second aspect, in a second possible implementation manner, the preset pressure is any value within a range that is from equal to or greater than 0.5 N to equal to or less than 2.5 N.

According to a third aspect, a terminal control apparatus is provided and includes:

a determining unit, configured to determine whether a first specified area on a surface of a terminal has more than a specified number of positions on which pressure exceeds preset pressure; and

an executing unit, configured to execute, when it is determined that the first specified area on the surface of the terminal has more than a specified number of positions on which the pressure exceeds the preset pressure, an operation corresponding to a user action in a second specified area on the surface of the terminal.

With reference to the third aspect, in a first possible implementation manner, the specified number is any integer within a range that is equal to or greater than 1.

With reference to the third aspect or the first possible implementation manner of the third aspect, in a second possible implementation manner, the preset pressure is any value within a range that is from equal to or greater than 0.5 N to equal to or less than 2.5 N.

According to the terminal provided in the first aspect, the terminal control method provided in the second aspect, and the terminal control apparatus provided in the third aspect, a user may synchronize actions in a first specified area and a second specified area on a surface of a terminal. If the first specified area has more than a specified number of positions on which pressure exceeds preset pressure, an operation corresponding to a user action in the second specified area is executed. One operation may be implemented without a need of multiple actions, and a misoperation of the user may be prevented, thereby implementing a shortcut operation and improving operation efficiency of the user.

### BRIEF DESCRIPTION OF DRAWINGS

The accompanying drawings are used to provide a further understanding of the present invention and constitute a part of the specification. They, together with the embodiments of the present invention, are used to explain the present invention and do not constitute a limit on the present invention. Among the accompanying drawings:

FIG. 1 is a schematic structural diagram of a terminal according to an embodiment of the present invention;

FIG. 2 is a side view schematic diagram and a front view schematic diagram of a terminal according to an embodiment of the present invention;

FIG. 3 is a flowchart of a terminal control method according to an embodiment of the present invention; and

FIG. 4 is a schematic structural diagram of a terminal control apparatus according to an embodiment of the present invention.

### DESCRIPTION OF EMBODIMENTS

To provide a solution which enables a terminal to implement a shortcut operation, embodiments of the present invention provide a terminal and a terminal control method and apparatus. The following describes preferable embodiments of the present invention with reference to the accompanying drawings of the specification. It should be understood that, the preferable embodiments described herein are used merely to describe and explain the present invention, but are not used to limit the present invention. In addition, under a situation without a conflict, the embodiments in this application and features in the embodiments may be combined mutually.

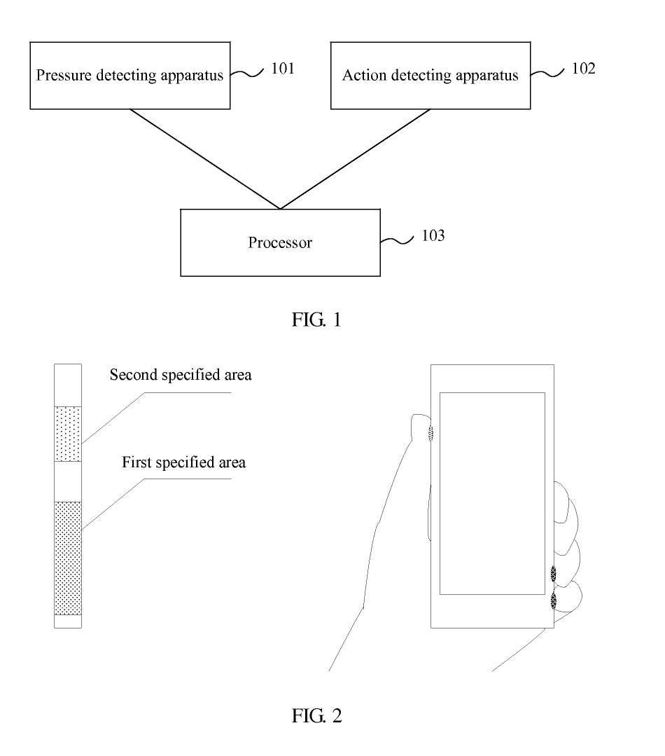

An embodiment of the present invention provides a terminal, as shown in FIG. 1, including:

a pressure detecting apparatus 101, configured to detect pressure on various positions in a first specified area on a surface of the terminal;

an action detecting apparatus 102, configured to detect a user action in a second specified area on the surface of the terminal; and

a processor 103, configured to execute, when it is determined that the first specified area on the surface of the terminal has more than a specified number of positions on which pressure exceeds preset pressure, an operation corresponding to a user action in the second specified area on the surface of the terminal.

When it is determined that the first specified area on the surface of the terminal does not have more than a specified number of positions on which the pressure exceeds preset pressure, the processor 103 does not execute the operation corresponding to the user action in the second specified area on the surface of the terminal,

where, the specified number is any integer value within a range that is equal to or greater than 1, and the preset pressure is any value within a range that is from equal to or greater than 0.5 N to equal to or less than 2.5 N.

The foregoing pressure detecting apparatus 101 may specifically be a pressure sensor bar or a capacitive touchscreen located on an inner side of the first specified area on the surface of the terminal, and the action detecting apparatus 102 may specifically be a capacitive touchscreen located on a inner side of the second specified area on the surface of the terminal.

Specifically, the user action in the second specified area on the surface of the terminal may be a pressing action or may also be a sliding action.

According to different current working status of a terminal, the operation corresponding to the user action in the second specified area on the surface of the terminal may specifically be multiple types of different operations. For example, when the terminal is in screen locked status, the operation corresponding to the user action in the second specified area may specifically be a screen unlocking operation; when the terminal is playing a video, the operation corresponding to the user action in the second specified area may specifically be a pausing or playing operation; and when the terminal is browsing a web page, the operation corresponding to the user action in the second specified area may specifically be a web page scrolling operation.

When the foregoing terminal is specifically a terminal such as a mobile phone, preferably, the specified number may be 2, and specific positions of the first specified area and second specified area on the surface of the terminal may be shown in FIG. 2, where, the first specified area may be located in a lower part of a side of the terminal and the second specified area may be located in an upper part of the side of the terminal. A processor determines whether the first specified area on the surface of the terminal has more than two positions on which the pressure exceeds the present pressure, and executes, when it is determined that the first specified area on the surface of the terminal has more than two positions on which the pressure exceeds the preset pressure, the operation corresponding to the user action in the second specified area on the surface of the terminal. In this case, a user may use a single hand to achieve flexible control over the terminal. The thumb may perform an action in the second specified area and the other four fingers may perform an action in the first specified area. By using a single hand to hold and press the terminal, the shortcut operation may be implemented, increasing use experience of a user. Furthermore, by setting the specified number to 2, not only holding habits of different users are considered and but also a misoperation can be prevented. The preset pressure may be specifically set according to an actual situation such as terminal weight and the user's grip strength.

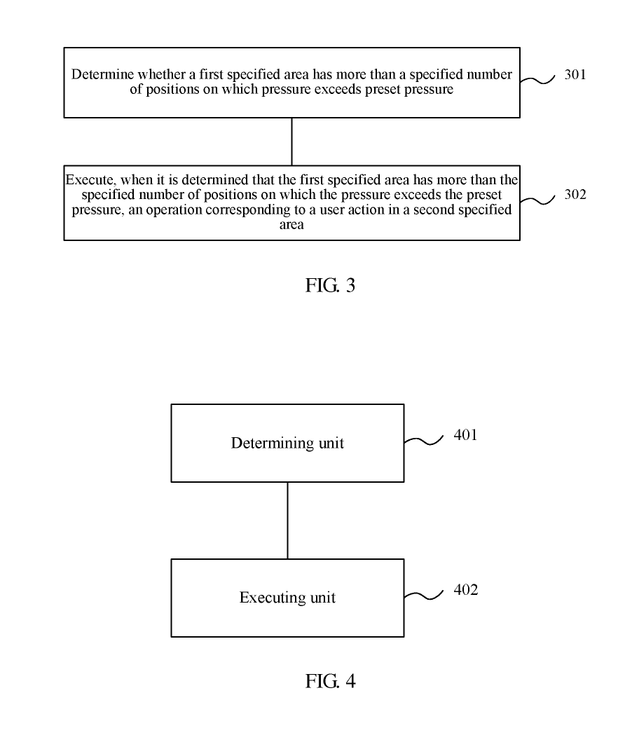

An embodiment of the present invention provides a terminal control method, as shown in FIG. 3, including:

Step 301: Determine whether a first specified area on a surface of a terminal has more than a specified number of positions on which pressure exceeds preset pressure.

Step 302: Execute, when it is determined that the first specified area on the surface of the terminal has more than the specified number of positions on which the pressure exceeds the preset pressure, an operation corresponding to a user action in the second specified area on the surface of the terminal; and

do not execute, when it is determined that the first specified area on the surface of the terminal does not have more than the specified number of positions on which the pressure exceeds the preset pressure, the operation corresponding to the user action in the second specified area on the surface of the terminal.

The specified number is any integer value within a range that is equal to or greater than 1, and the preset pressure is any value within a range that is from equal to or greater than 0.5 N to equal to or less than 2.5 N.

The foregoing terminal control method applies to various terminals, for example, a mobile phone.

The user action in the second specified area on the surface of the terminal may specifically be a pressing action or may also be a sliding action.

According to different current working status of a terminal, the operation corresponding to the user action in the second specified area on the surface of the terminal may specifically be multiple types of different operations. For example, when the terminal is in screen locked status, the operation corresponding to the user action in the second specified area may specifically be a screen unlocking operation; when the terminal is playing a video, the operation corresponding to the user action in the second specified area may specifically be a pausing or playing operation; and when the terminal is browsing a web page, the operation corresponding to the user action in the second specified area may specifically be a web page scrolling operation.

When the foregoing terminal is specifically a terminal such as a mobile phone, preferably, the specified number may be 2, the first specified area may be located in a lower part of a side of the terminal, and the second specified area may be located in an upper part of a side of the terminal. A processor determines whether the first specified area on the surface of the terminal has more than two positions on which the pressure exceeds the present pressure, and executes, when it is determined that the first specified area on the surface of the terminal has more than two positions on which the pressure exceeds the preset pressure, the operation corresponding to the user action in the second specified area on the surface of the terminal. In this case, a user may use a single hand to achieve flexible control over the terminal. The thumb may perform an action in the second specified area and the other four fingers may perform an action in the first specified area. By using a single hand to hold and press a terminal, a shortcut operation may be implemented, thereby improving use experience of the user.

It may be seen that, by using the method provided in this embodiment of the present invention, in the foregoing embodiment, one operation may be implemented without a need of multiple actions, and a misoperation of a user may be prevented, thereby implementing a shortcut operation and improving operation efficiency of the user.

Based on a same invention idea and according to the terminal control method provided in the foregoing embodiment of the present invention, correspondingly, an embodiment of the present invention provides a terminal control apparatus. A schematic structural diagram of the terminal control apparatus is shown in FIG. 4, specifically including:

a determining unit 401, configured to determine whether a first specified area on a surface of a terminal has more than a specified number of positions on which pressure exceeds preset pressure; and

an executing unit 402, configured to execute, when it is determined that the first specified area on the surface of the terminal has more than the specified number of positions on which the pressure exceeds the preset pressure, an operation corresponding to a user action in a second specified area on the surface of the terminal.

Further, the first specified area is located in a lower part of a side of the terminal and the second specified area is located in an upper part of a side of the terminal.

Further, the specified number is any integer value within the range that is equal to or greater than 1.

Preferably, the specified number is 2.

Further, the preset pressure is any value within the range that is from equal to or greater than 0.5 N to equal to or less than 2.5 N.

A function of each of the foregoing units may correspond to a corresponding processing step in a process shown in FIG. 3, and repeated description is not provided herein.

In conclusion, using the solutions provided in the embodiments of the present invention can solve a problem that a shortcut operation cannot be implemented on a terminal, thereby improving operation efficiency and use experience of a user.

A person of ordinary skill in the art may understand that the embodiments of the present invention may be provided as a method, system, or computer program product. Therefore, the present invention may be used in a form of complete hardware embodiment, complete software embodiment, or embodiment combining software and hardware aspects. Furthermore, the present invention may be used in a form of computer program product implemented on one or more computer-applicable storage media (which include but are not limited to magnetic disk storage devices, CD-ROMs, and optical storage devices) that include computer-applicable program code.

The present invention is described with reference to the flowcharts and/or block diagrams of the methods, devices (systems), and computer program products according to the embodiments of the present invention. It should be understood that every process and/or block in the flowcharts and/or block diagrams and combinations of processes and/or blocks in the flowcharts and/or block diagrams may be implemented by computer program instructions. The computer program instructions may be provided to processors of universal computers, dedicated computers, embedded processing machines, or other programmable data processing devices to generate a machine to enable the instructions executed by the processors of the computers or other programmable data processing devices to generate apparatuses for implementing the functions specified in one process or multiple processes in the flowcharts and/or one block or multiple blocks in the block diagrams.

The computer program instructions may also be stored in computer readable storage devices that may guide computers or other programmable data processing devices to work in specified modes, so that the instructions stored in the computer readable storage devices generate products that include instruction apparatuses, where, the instruction apparatuses implement the functions specified in one process or multiple processes in the flowcharts and/or one block or multiple blocks in the block diagrams.

The computer program instructions may also be loaded to computers or other computer-readable storage working in a specific manner of a programmable data processing devices, to enable the instructions stored in the computer-readable storage to produce a product including instructions device. The instructions device implements the functions specified in one process or multiple processes in the flowcharts and/or one block or multiple blocks in the block diagrams.

Although preferable embodiments of the present invention have been described, a technical person skilled in the art may make, once understanding the basic creative concept, additional changes and modifications to the embodiments. Therefore, the accompanying claims are intended to be explained as including the preferable embodiments and all changes and modifications that fall within the scope of the present invention.

Apparently, a technical person skilled in the art may make various types of changes or variations to the embodiments of the present invention without departing from the true intention and scope of the embodiments of the present invention. Thus, if these changes and variations of the embodiments of the present invention are within the claims of the present invention and scope of technical equivalents, the present invention is also intended to include these changes and variations.

What is claimed is:

1. A terminal, comprising:
a pressure detecting apparatus, configured to detect pressure on various positions in a first specified area on a surface of the terminal;
an action detecting apparatus, configured to detect a user action in a second specified area on the surface of the terminal; and
a processor, configured to execute, when it is determined that the first specified area on the surface of the terminal has more than a specified number of positions on which the pressure exceeds preset pressure, an operation corresponding to the user action in the second specified area on the surface of the terminal.

2. The terminal according to claim 1, wherein, the pressure detecting apparatus is a pressure sensor bar or a capacitive touchscreen located on an inner side of the first specified area on the surface of the terminal, and the action detecting apparatus is a capacitive touchscreen located on an inner side of the second specified area on the surface of the terminal.

3. The terminal according to claim 1, wherein, the first specified area is located in a lower part of a side of the terminal and the second specified area is located in an upper part of a side of the terminal.

4. The terminal according to claim 1, wherein, the specified number is any integer value within a range that is equal to or greater than 1.

5. The terminal according to claim 1, wherein, the preset pressure is any value within a range that is from equal to or greater than approximately 0.5 N to equal to or less than approximately 2.5 N.

6. A terminal control method, comprising:
determining whether a first specified area on a surface of a terminal has more than a specified number of positions on which pressure exceeds preset pressure; and
executing, when it is determined that the first specified area on the surface of the terminal has more than the specified number of positions on which the pressure exceeds the preset pressure, an operation corresponding to a user action in a second specified area on the surface of the terminal.

7. The method according to claim 6, wherein, the preset pressure is any value within a range that is from equal to or greater than approximately 0.5 N to equal to or less than approximately 2.5 N.

8. The method according to claim 6, wherein, the specified number is any integer value within a range that is equal to or greater than 1.

9. The method according to claim 7, wherein, the preset pressure is any value within a range that is from equal to or greater than approximately 0.5 N to equal to or less than approximately 2.5 N.

10. A terminal control apparatus, comprising:
a determining unit, configured to determine whether a first specified area on a surface of a terminal has more than a specified number of positions on which pressure exceeds preset pressure; and
an executing unit, configured to execute, when it is determined that the first specified area on the surface of the terminal has more than the specified number of positions on which the pressure exceeds the preset pressure, an operation corresponding to a user action in a second specified area on the surface of the terminal.

11. The apparatus according to claim 10, wherein, the preset pressure is any value within a range that is equal to or greater than approximately 0.5 N to equal to or less than approximately 2.5 N.

12. The apparatus according to claim 10, wherein, the specified number is any integer value within a range that is equal to or greater than 1.

13. The apparatus according to claim 12, wherein, the preset pressure is any value within a range that is equal to or greater than approximately 0.5 N to equal to or less than approximately 2.5 N.
